(19) United States
(12) Patent Application Publication
(10) Pub. No.: US 2021/0313673 A1
(43) Pub. Date: Oct. 7, 2021

(54) STRUCTURE AT LEAST PARTIALLY TRANSPARENT TO RADIO FREQUENCY SIGNALS

(71) Applicant: BAE SYSTEMS plc, London (GB)

(72) Inventor: Ashley Lloyd Wade, Chelmsford Essex (GB)

(73) Assignee: BAE SYSTEMS plc, London (GB)

(21) Appl. No.: 17/267,264

(22) PCT Filed: Aug. 14, 2019
(86) PCT No.: PCT/GB2019/052286

§ 371 Date: Feb. 9, 2021

(30) Foreign Application Priority Data
Aug. 16, 2018 (EP) 18275122.2
Aug. 16, 2018 (GB) 1813374.4

(51) Int. Cl. H01Q 1/28; H01Q 1/42

(52) U.S. Cl. CPC H01Q 1/281; H01Q 1/42

(57) ABSTRACT

The present invention provides a structure at least partially transparent to radio frequency signals, the structure being formed of a tessellated polyhedral material comprising a plurality of polyhedral cells. The present invention also provides a method of manufacturing the same.

### FIELD OF THE INVENTION

The present invention relates to a structure at least partially transparent to radio frequency signals and a method of manufacturing the same.

### BACKGROUND ART

Materials for use in housings and bases for radio frequency (RE) antennas, such as radars, are known. These materials include foams and traditional honeycombs. However, foams tend to be dense and hence heavy in order to be structurally supportive. Traditional honeycombs tend to be anisotropic to RF signals, which can have a negative impact on a sensor's signal processing capability.

### SUMMARY

According to a first aspect of the present invention, there is provided a structure at least partially transparent to radio frequency signals, the structure being formed of a tessellated polyhedral material comprising a plurality of polyhedral cells.

Each of the plurality of polyhedral cells may be a rhombic dodecahedral. Alternatively, each of the polyhedral cells may be a triangular prism, hexagonal prism, cube, truncated octahedron, gyrobifastigium, elongated dodecahedron, or non-self-intersecting quadrilateral prism.

The tessellated polyhedral material may comprise a first polyhedral cell and a second polyhedral cell, wherein the first polyhedral cell has a different shape to the second polyhedral cell. Preferably, the first polyhedral cell is a tetrahedron and the second polyhedral cell is an octahedron.

The structure may further comprise three third polyhedral cells, wherein the first polyhedral cell is an octahedron, the second polyhedral cell is a truncated octahedron and each of the three third polyhedral cells is a cube.

Each of the plurality of polyhedral cells may be filled with a filler material. The filler material may be conductive and/or magnetic. Alternatively, the filler material may be an insulator. For example, the filler material may be a foam or other polymer. The foam or polymer may be doped with nanoscale graphitic particles, carbon nanotubes, barium hexaferrite, barium titanate or titanium dioxide.

Preferably, each of the plurality of polyhedral cells comprises a plurality of faces and wherein each face is between 0.1 mm and 4 mm thick. More preferably, each face of the plurality of polyhedral cells is between 0.3 mm and 2 mm thick. Even more preferably, each face of the plurality of polyhedral cells is about 0.5 mm thick. Alternatively, each of the plurality of polyhedral cells may comprise a lattice structure.

Preferably, the structure is between 50 and 600 mm thick. More preferably, the structure is between 200 and 500 mm thick. Even more preferably, the structure is 300 mm thick.

The plurality of polyhedral cells may be formed from a filament material comprising a thermoplastic polymer, a ceramic or a composite. For example, the filament material may comprise one of polyactide (PLA), Acrylonitrile Butadiene Styrene (ABS), Nylon, or Polyethylene Terephthalate (PET).

The filament material may be doped with conductive and/or magnetic particles, such that electrical parameters of the tessellated polyhedral material can be selected. The conductive/magnetic particles may include carbon, iron, carbon nanotubes, graphene, metal-coated carbon nanotubes. Additionally or alternatively, the structure may comprise a conductive and/or magnetic ink disposed on at least part of a surface of the tessellated polyhedral material. The surface may be the inside surface and/or the outside surface of the tessellated polyhedral material. In some embodiments, individual cells are selected to be coated in a conductive and/or magnetic ink. The ink may contain iron oxide.

According to a second aspect of the present invention, there is provided a sensor fairing comprising the structure according to the first aspect. The sensor fairing may be a radome. According to another aspect of the present invention, there is provided a support structure for supporting an RF antenna, the support structure comprising the structure according to the first aspect.

According to a third aspect of the present invention, there is provided a radar absorbent material, the radar absorbent material being formed of a tessellated polyhedral material comprising a plurality of polyhedral cells, wherein either:

each of the plurality of polyhedral cells comprises conductive and/or magnetic particles; or

the tessellated polyhedral material is coated in a conductive and/or magnetic ink.

The radar absorbent material may be opaque to radio frequency signals.

According to a fourth aspect of the present invention, there is provided a structure having a first section at least partially transparent to radio frequency signals and a second section substantially opaque to radio frequency signals, wherein the first section and second section are formed of a tessellated polyhedral material comprising a plurality of polyhedral cells.

The first section may comprise the structure according to the first aspect.

Preferably, either:

each of the plurality of polyhedral cells in the second section may comprise conductive and/or magnetic particles; or

an inner or outer surface of the tessellated polyhedral material in the second section may be coated in a conductive and/or magnetic ink.

According to a fifth aspect of the present invention, there is provided a method of manufacturing a structure at least partially transparent to RF signals, comprising using fused deposition modelling to form a tessellated polyhedral material comprising a plurality of polyhedral cells from a filament material.

The method further may further comprise mixing conductive and/or magnetic particles with the filament material such that the electrical parameters of the tessellated polyhedral material can be selected. Additionally or alternatively, the method may comprise applying a conductive and/or magnetic ink to at least part of a surface of the tessellated polyhedral material.

### BRIEF DESCRIPTION OF THE DRAWINGS

Embodiments will now be described, by way of non-limiting example, with reference to the accompanying drawings, in which:

FIG. 1 is a side view of a radome according to an embodiment;

FIG. 2 is a perspective view of a traditional honeycomb;

FIG. 3 is a perspective view of a tessellated polyhedral structure according to an embodiment;

FIG. 4 is a perspective view of a tessellated polyhedral structure according to an embodiment; and

FIG. 5 is a graph comparing the RF transmission loss through a prior art honeycomb structure and the structure shown in FIG. 3.

### DETAILED DESCRIPTION

Embodiments herein relate generally to structures for RF (radio frequency) antennas. These structures include for example housings, fairings, radomes, and casings for protecting antennas while still allowing an RF signal to be received or transmitted therethrough. The structures described herein may extend around a vehicle. Part of the structure may be transparent to RF signals, while another part may be semi-transparent or even opaque to RF signals. Some structures may require an element of selective signal attenuation to prevent a vehicle or building to which the antenna is mounted affecting a signal measurement. In other words, embodiments relate to materials for use in structures through which RF signals need to pass. RF signals include signals with all frequencies between about 30 Hz and 500 GHz. In other words, RF signals include microwave signals, which are signals having a frequency of between about 300 MHz and 300 GHz.

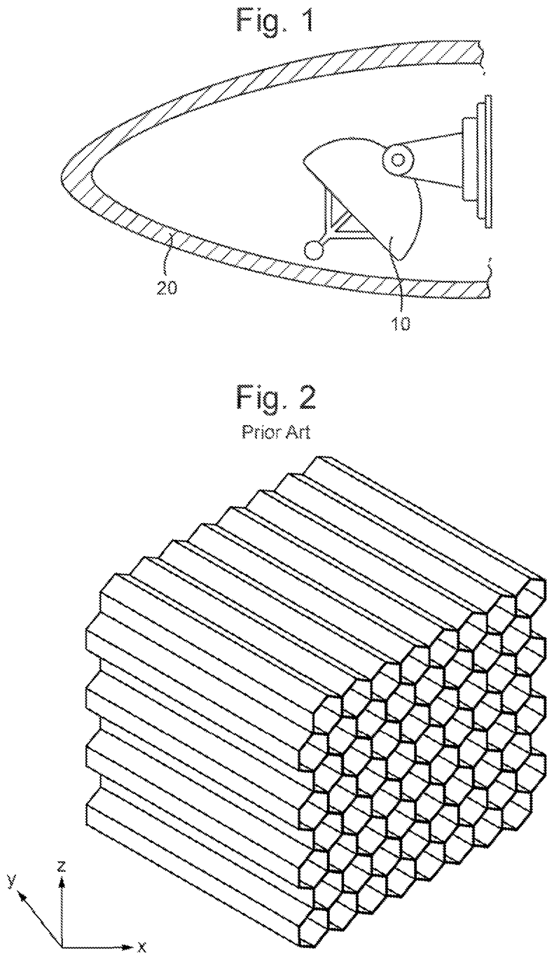

FIG. 1 shows a structure 20 in the form of a radome for an aircraft, for example a fighter jet or a civilian airliner. Radomes are an example of housings for protecting signal emitters/receivers (also referred to herein as antennas) 10, specifically radar emitters/receivers, from atmospheric conditions. Radomes are typically transparent to radio waves. Typically, a radome is disposed on the nose of an aircraft, however, aircraft such as Airborne Early Warning and Control aircraft have radomes disposed on the tail, wing, ventral or dorsal sections of the aircraft.

Other types of sensors, such as Magnetic Anomaly Detectors, Global Navigation Satellite System (GNSS), Wi-Fi, satellite communication or ADS-B, also require housings such as fairings to protect their signal receivers and/or transmitters (i.e. antennas) 10. It is advantageous to make housings for antennas 10 lightweight yet structurally resilient and isotropic to the frequency of the electromagnetic spectrum measured by the sensor. Anisotropic barriers result in sensor anomalies such as lensing caused by varying electrical path lengths in different directions.

FIG. 2 shows a typical prior art material construction used in structures for housing RF antennas. The material takes the form of a traditional honeycomb. The traditional honeycomb is an array of hollow cells formed between thin vertical walls. The cells are often columnar and hexagonal in shape. A honeycomb-shaped structure provides a material with minimal density and relative high out-of-plane compression properties and out-of-plane shear properties. However, traditional honeycombs tend to be anisotropic to RF signal propagation.

Another prior art alternative to the traditional honeycomb is to use a foam, such as a Rohacell WF. Foams tend to be isotropic to radiation, however high density foams (of the order of 150 kg/m³) are required to make a structure supportive or resistant to compression. This tends to make the housing relatively heavy, which is not desirable when the housing is disposed on a vehicle where weight needs to be minimised, such as an aircraft or high performance car.

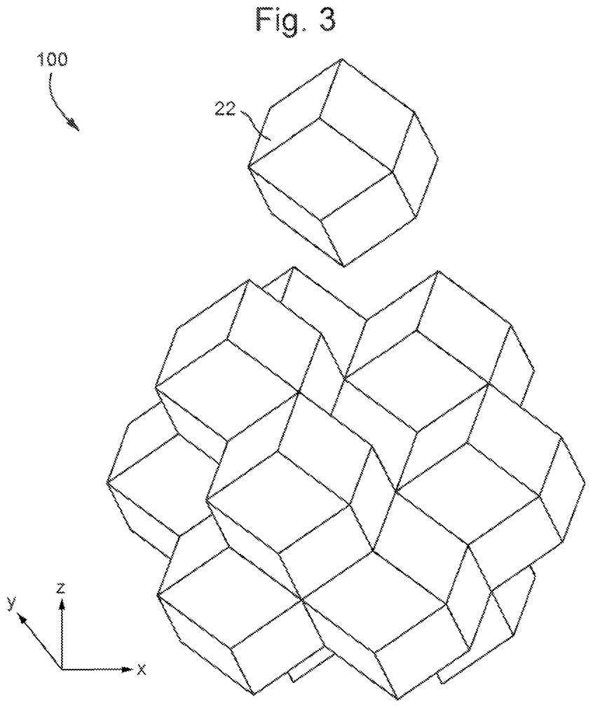

FIG. 3 shows a tessellated polyhedral structure 100 for use in forming a structure 20 according to an embodiment. In this embodiment, the tessellated polyhedral structure 100 (or polyhedral honeycomb) comprises a plurality of rhombic dodecahedra 22 (each rhombic dodecahedron being a cell). The rhombic dodecahedron 22 is a convex polyhedron with twelve congruent rhombic faces. The diagonals of the rhombi are in the ratio 1:√2. The rhombic dodecahedron 22 is a space-filling polyhedron.

In the tessellated polyhedral structure 100, three cells 22 meet at each edge. The tessellated polyhedral structure 100 is thus cell-transitive, face-transitive and edge-transitive; but it is not vertex-transitive, as it has two kinds of vertex. The vertices with the obtuse rhombic face angles have four cells 22. The vertices with the acute rhombic face angles have six cells 22.

A tessellated rhombic dodecahedron tends to exhibit mechanical compressive strength closer to isotropy than a traditional honeycomb. Additionally, the tessellated rhombic dodecahedron is substantially electrically isotropic. However, while tessellation of a rhombic dodecahedron is advantageous, in other embodiments different types of polyhedrons are tessellated to form the structure 20. Particularly, the structure 20 is formed of tessellated space-filling polyhedrons. For example, in one embodiment, the structure 20 is formed of a combination of tetrahedrons and octahedrons. In another embodiment, the structure 20 is formed of a combination of octahedrons, truncated octahedrons and cubes. The octahedrons, truncated octahedrons and cubes are combined in the ratio 1:1:3. In another embodiment, the structure 20 is formed of a space-filling compound of tetrahedrons and truncated tetrahedrons. In further alternative embodiments, the structure 20 is formed of tessellated triangular prisms, tessellated hexagonal prisms, tessellated cubes, tessellated truncated octahedrons, tessellated gyrobifastigiums, tessellated elongated dodecahedrons, tessellated squashed dodecahedrons or a tessellation of any non-self-intersecting quadrilateral prism.

While FIG. 3 shows cells 22 having a plurality of faces, in other embodiments the cells 22 comprise a framework, or lattice, structure. In other words, here the tessellated polyhedral structure 100 is an open cell structure. In order to protect the antenna 10 or to provide an aerodynamic surface, the outside surface of the tessellated polyhedral structure 100 is coated in a thin layer of material such as fabric, paint, quart glass or other low-loss thin material.

In some embodiments, each cell 22 or selected cells 22 are filled with a filler material. The filler material may be conductive and/or magnetic. Alternatively, the filler material may be an insulator. For example, the filler material may be a foam or polymer. The foam or polymer may be doped with nanoscale graphitic particles, carbon nanotubes, barium hexaferrite, barium titanate or titanium dioxide. Moreover, in some embodiments, each cell 22 or selected cells 22 are formed as solid blocks. By filling the cells 22, particularly with a foam, the mechanical strength of the cells 22 and consequently the tessellated polyhedral structure 100 tends to be improved.

The thickness of the faces of each cell 22 is about 0.5 mm. That said, the thickness of each face could be between 0.1 mm and 4 mm.

The thickness of the structure 20 is between 50 mm and 600 mm. In other words, where the structure 20 is a radome, the depth of the structure 20 from the outer most point, where it contacts the air, to the inner most point where it faces the radar antenna 10, is between 50 mm and 600 mm.

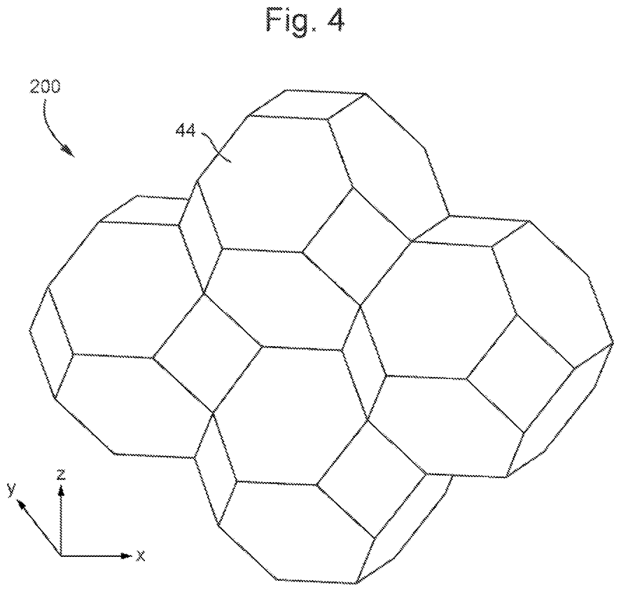

FIG. 4 shows a tessellated polyhedral structure 200 according to another embodiment. Here, the cells 44 forming the tessellated polyhedral structure 200 are bitruncated cubes, or truncated octahedrons. In other words, the tessellated polyhedral structure 200 is a bitruncated cubic honeycomb also known as a truncated octahedrille.

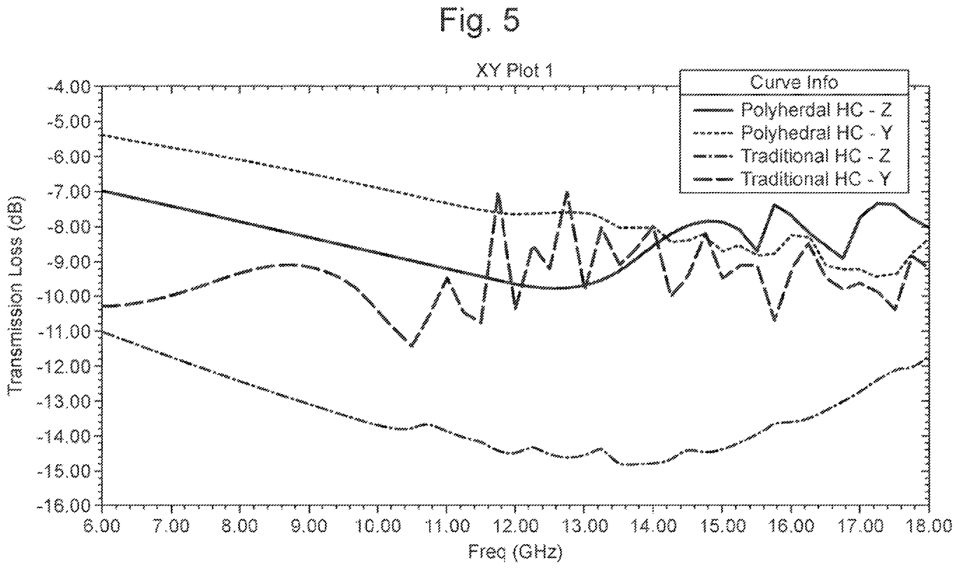

As shown in FIG. 5, the transmission loss of a tessellated polyhedral structure 100 comprising a plurality of rhombic dodecahedrons tends to increase at around 12 GHz. This is a result of the cell 22 size becoming approximately half a wavelength, at which point the cells 22 become resonant. Therefore, it can be advantageous to mix space-filling polyhedrons of different sizes or shapes in the same tessellated material, as this tends to increase the bandwidth of the tessellated polyhedral structure 100 and damp resonant frequencies. Smaller polyhedrons resonate at a higher frequency.

In one embodiment, additive layer manufacturing is used to manufacture the tessellated polyhedral structure 100. More specifically, in one embodiment fused deposition modelling (FDM) is used to create the tessellated polyhedral structure 100. This 3D printing technique allows the complex shapes to be printed directly. The technique also provides control over the electrical parameters of the material.

The tessellated polyhedral structure 100 is preferably manufactured from a filament material. The filament material is a thermoplastic polymer, such as Polyactide (PLA), Acrylonitrile Butadiene Styrene (ABS), or Nylon. However, other materials such as ceramic and composites may be used. Although FIG. 3 shows the tessellated polyhedral structure 100 as being built of a number of distinct cells 22, this is only for ease of understanding the structure. In preferred embodiments, the tessellated polyhedral structure 100 is built up in layers, and therefore the cells 22 are integrally formed.

In some embodiments, the filament material is mixed with carbon or metallic particles such as iron, before the filament material is formed into a tessellated polyhedral structure 100. This introduces an electrical transmission loss into the tessellated polyhedral structure 100, which is beneficial in some circumstances to the system performance. Moreover, by selectively filtering which frequencies of the electromagnetic spectrum pass through the structure 20 (i.e. selectively absorbing particular frequencies), the resolution of the sensor coupled to the antenna 10 can be improved. In other words, the structure 20 in some embodiments is a frequency selective surface.

In some embodiments, different filament materials are used for different parts of the structure 20. For example, an area of the structure 20 in the intended field of regard of the antenna 10 may be an RE-transparent window, while the rest of the structure 20 may be opaque to RF signals. However, in both the transparent, or partially transparent, and opaque sections of the structure 20, the structure has the same tessellated polyhedral structure 100. In the opaque section, the tessellated polyhedral structure 100 is either coated in a conductive and/or magnetic ink or made from a filament material having conductive and/or magnetic particles mixed therein.

To balance RF absorption with antenna 10 effectiveness within a particular section of structure 20, the electrical properties of individual cells 22 within the tessellated polyhedral structure 100 can be adjusted by mixing (or not mixing) conductive and/or magnetic particles with the filament material. Therefore, a partially RF-transparent section of structure 20 can be constructed.

The filament material may also be mixed with non-conductive fibres such that the formed tessellated polyhedral structure 100 tends to have improved mechanical properties.

In another embodiment, the tessellated polyhedral structure 100 is coated with a conductive and/or magnetic ink in order to introduce the electrical transmission loss. Coating may be performed after the tessellated polyhedral structure 100 is formed, or the ink may be co-disposed with each layer of the tessellated polyhedral structure 100. The ink may be disposed on the inside surface of the tessellated polyhedral structure, or the outside surface. The ink may contain iron oxide, for example.

By using additive layer manufacturing and varying the properties of some cells 22, a surface of a vehicle can be manufactured in which some areas, such as those adjacent antennas 10, are transparent to RF signals, and other areas are opaque or not transparent to RF signals.

FIG. 5 is a comparison of the electric properties of a structure 20 made from an undoped tessellated polyhedral structure 100 according to an embodiment of the present invention, and a structure made from a traditional honeycomb. As shown in the graph, in the Z axis the tessellated polyhedral structure 100 exhibits a roughly 4 dB improvement (i.e. minimisation) of transmission loss across the frequency 6 GHz to 18 GHz, compared with the traditional honeycomb. In the Y axis, the improvement in transmission loss exhibited by the tessellated polyhedral structure 100 reduces at frequencies above about 12 GHz. However, at 6 GHz, the tessellated polyhedral structure 100 exhibits an about 1.5 dB reduction in transmission loss.

While a material 100 for use in making a housing 20 for an RF antenna 10 has been described above, the material 100 is also beneficial for making other structures related to RF antennas. For example, the material 100 may be used in a support structure onto which an RF antenna is attached. Here, it is particularly advantageous to dope the material 100 with particles for attenuating RF signals such that the vehicle or building to which the support structure is attached does not skew the signal detected by the antenna 10. The structure 20 may also be the skin of a vehicle, for example an aircraft, ship or submarine. The skin may be divided into sections, some of which may be opaque to RF signals while others are transparent or partially transparent to RF signals.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A structure at least partially transparent to radio frequency signals, the structure being formed of a tessellated polyhedral material comprising a plurality of polyhedral cells.

2. The structure according to claim 1, wherein each of the plurality of polyhedral cells is a rhombic dodecahedral.

3. The structure according to claim 1, wherein the tessellated polyhedral material comprises a first polyhedral cell and a second polyhedral cell, wherein the first polyhedral cell has a different shape to the second polyhedral cell.

4. The structure according to claim 3, wherein the first polyhedral cell is a tetrahedron and the second polyhedral cell is an octahedron.

5. The structure according to claim 3, further comprising three third polyhedral cells, wherein the first polyhedral cell is an octahedron, the second polyhedral cell is a truncated octahedron, and each of the three third polyhedral cells is a cube.

6. The structure according to claim 1, wherein each of the plurality of polyhedral cells is filled with a filler material.

7. The structure according to claim 1, wherein each of the plurality of polyhedral cells comprises a plurality of faces and wherein each face is between 0.1 mm and 4 mm thick.

8. The structure according to claim 1, wherein the structure is between 50 and 600 mm thick.

9. The structure according to claim 1, wherein the plurality of polyhedral cells are formed from a filament material comprising a thermoplastic polymer, a ceramic or a composite.

10. The structure according to claim 9, wherein the filament material is doped with conductive and/or magnetic particles, such that electrical parameters of the tessellated polyhedral material can be selected.

11. The structure according to claim 1, comprising a conductive and/or magnetic ink disposed on at least part of a surface of the tessellated polyhedral material.

12. A sensor fairing comprising the structure according to claim 1.

13. A method of manufacturing a structure at least partially transparent to RF signals, the method comprising using fused deposition modelling to form a tessellated polyhedral material comprising a plurality of polyhedral cells from a filament material.

14. The method according to claim 13, wherein the method further comprises mixing conductive and/or magnetic particles with the filament material such that the electrical parameters of the tessellated polyhedral material can be selected.

15. The method according to claim 13, wherein the method further comprises applying a conductive and/or magnetic ink to at least part of a surface of the tessellated polyhedral material.

16. A structure having a first section at least partially transparent to radio frequency signals and a second section substantially opaque to radio frequency signals, wherein the first section and second section are formed of a tessellated polyhedral material comprising a plurality of polyhedral cells.

17. The structure according to claim 16, wherein each of the plurality of polyhedral cells is a rhombic dodecahedral.

18. The structure according to claim 16, wherein either:
each of the plurality of polyhedral cells in the second section comprises conductive and/or magnetic particles; or
an inner or outer surface of the tessellated polyhedral material in the second section is coated in a conductive and/or magnetic ink.

19. The structure according to claim 16, wherein the plurality of polyhedral cells comprises a first polyhedral cell and a second polyhedral cell, wherein the first polyhedral cell has a different shape to the second polyhedral cell.

20. The structure according to claim 16, wherein the structure is the skin of a vehicle.
